(19) United States
(12) Patent Application Publication
(10) Pub. No.: US 2011/0029625 A1
(43) Pub. Date: Feb. 3, 2011

(54) METHOD AND SYSTEM FOR PROCESSING EMAIL ATTACHMENTS

(75) Inventors: Yuan Cheng, Beijing (CN); Yue Ma, Beijing (CN); Shuang Qin, Beijing (CN); Min Qu, Beijing (CN)

Correspondence Address: CAREY, RODRIGUEZ, GREENBERG & PAUL, LLP;STEVEN M. GREENBERG, 950 PENINSULA CORPORATE CIRCLE, SUITE 2022, BOCA RATON, FL, 33487, US

(73) Assignee: INTERNATIONAL BUSINESS MACHINES CORPORATION, Armonk, NY (US)

(21) Appl. No.: 12/845,111

(22) Filed: Jul. 28, 2010

(30) Foreign Application Priority Data
Jul. 31, 2009 (CN) 2009101614669

(51) Int. Cl. G06F 15/16

(52) U.S. Cl. 709/206

(57) ABSTRACT

The present invention provides a method and system for processing email attachments. The method includes determining that a local file is attached as an email attachment in the email; creating a corresponding relationship record of the email attachment and the local file; determining that the email attachment is modified; and replacing the local file with the modified email attachment according to the corresponding relationship record automatically.

### TECHNICAL FIELD OF THE INVENTION

The present invention relates to email attachments, in particular, to a method and system for processing email attachments.

### BACKGROUND OF THE INVENTION

Currently, emails are an important means to communicate and exchange among people. Specifically, in transnational companies in which the service range covers wide geographic locations and time zones, emails almost are the most important mean to exchange information. Email attachments are widely used for conveniently and simply transferring files. However, after a local file is attached as an email attachment, if the user modifies the email attachment and wants to replace the local file with the modified email attachment, then the user can only re-modify the local file, or if the user modifies the local file and wants to attach the modified local file as the email attachment, then the user must re-attach the modified local file as the email attachment. Since the user does not synchronize the email attachment and the local file immediately, a lot of files that have not been updated in time are left locally, thus causing more troubles for further use.

Consequently, a mechanism enabling the email attachment and the local file to be synchronized is required, which will efficiently synchronize the email attachment and the local file, improve work efficiency, and save time cost.

### SUMMARY OF THE INVENTION

In view of the deficiencies in the prior art, the present invention provides a method and system for processing email attachments.

According to an aspect of the present invention, a method for processing email attachments is provided, comprising: determining that a local file is attached as an email attachment in the email; creating a corresponding relationship record of the email attachment and the local file; determining that the email attachment is modified; and replacing the local file with the modified email attachment according to the corresponding relationship record automatically.

According to another aspect of the present invention, a method for processing email attachments is provided, comprising: determining that a local file is attached as an email attachment in the email; creating a corresponding relationship record of the email attachment and the local file; determining that the local file is modified and that the email is not sent yet; and replacing the email attachment in the email with the modified local file according to the corresponding relationship record.

According to another aspect of the present invention, a system for processing email attachments is provided, comprising: determining attachment means configured to determine that a local file is attached as an email attachment in the email; creating means configured to create a corresponding relationship record of the email attachment and the local file; determining modification means configured to determine that the email attachment is modified; and synchronizing means configured to replace the local file with the modified email attachment according to the corresponding relationship record automatically.

According to another aspect of the present invention, a system for processing email attachments is provided, comprising: determining attachment means configured to determine that a local file is attached as an email attachment in the email; creating means configured to create a corresponding relationship record of the email attachment and the local file; determining modification means configured to determine that the local file is modified and that the email is not sent yet; and synchronizing means configured to replace the email attachment in the email with the modified local file according to the corresponding relationship record, and update the corresponding relationship record.

The method and system for processing email attachments according to the embodiments of the present invention enables an association of the local file and the email attachment, and allows users to synchronize conveniently, quickly, and automatically, thereby saving workload and time cost for re-editing, re-storing and re-uploading the attachment by the user.

### BRIEF DESCRIPTION OF THE DRAWINGS

It is believed that, the features, advantages and objects of the Invention can be better understood from the following detailed description in conjunction with the attached figures, wherein:

FIG. 1 shows a method for processing email attachments according to the first embodiment of the present invention;

FIG. 2 shows a method for processing email attachments according to the second and third embodiment of the present invention;

FIG. 3 shows a method for processing email attachments according to the fourth embodiment of the present invention;

FIG. 4 shows a method for processing email attachments according to the fifth embodiment of the present invention;

FIG. 5 shows a block diagram of the system for processing email attachments according to the first embodiment of the present invention; and

FIG. 6 shows a block diagram of the system for processing email attachments according to the second and third embodiments of the present invention.

### DETAILED DESCRIPTION OF THE PREFERRED EMBODIMENTS

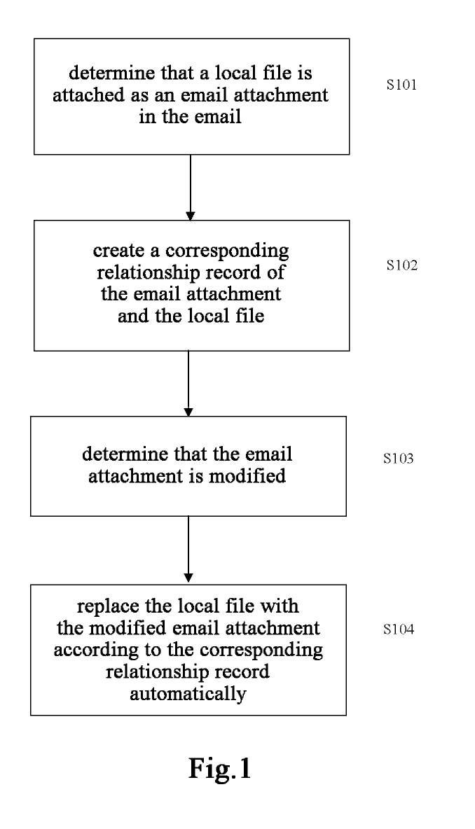

A method and system for processing email attachments according to an embodiment of the present invention will be described below in connection with the appended drawings. FIG. 1 shows a method for processing email attachments according to an embodiment of the present invention, comprising: in step S101, determining that a local file is attached as an email attachment in the email; in step S102, creating a corresponding relationship record of the email attachment and the local file; in step S103, determining that the email attachment is modified; and in step S104, replacing the local file with the modified email attachment according to the corresponding relationship record automatically.

In particular, in step S102 of creating a corresponding relationship record between the email attachment and the local file, each email attachment corresponds to a relationship record, wherein the corresponding relationship record includes identification information of the email attachment and identification information of the local file, wherein the identification information of the email attachment includes an email attachment identifier, such email attachment identifier is generated while the email attachment is created, and is used for identifying the email attachment uniquely, for example, the email attachment identifier can be composed of an email identifier corresponding to an email attachment attached with character string formed by a string of numeric and alphabet.

According to an embodiment of the present invention, the identification information of the email attachment may also include an email identifier, and the email identifier (mail ID) is generated while the email is created and is used for identifying the email uniquely. The identification information of the local file may include a path of the local file, the corresponding relationship record may be stored in the storage medium of the local computer as a table of corresponding relationship and can be updated automatically, for example, if a recorded email attachment or local file is updated or deleted, then the corresponding relationship record of the email attachment is also updated or deleted. A user can also modify the corresponding relationship record, and create a corresponding relationship record of the email attachment and local file to maintain synchronization. An example of a corresponding relationship record of an email attachment and a local file is shown in table 1 below, for example, a first corresponding relationship record includes: an email attachment identifier “NOTE123QWE test1doc_{—}1” and the path of the local file is “D:\work\test1.doc”, according to an embodiment of the present invention, it can also include a modified time tag of the local file, as shown in table 2, a first corresponding relationship record includes: an email identifier “NOTE123QWE”, an email attachment identifier “test1doc_{—}1”, the path of the local file “D:\work\test1.doc” and the modified time tag of the local file “2007-08-05-12:00:00”. According to an embodiment of the present invention, it can also include the file size of the local file.

TABLE 1

| email attachment identifier | path of local file |
|---|---|
| NOTE123QWEtest1doc_1 | D:\work\test1.doc |
| NOTE584ATWtest2doc_1 | D:\work\test2.doc |
| NOTE684ASTtest3doc_1 | D:\work\test3.doc |
| NOTE684ASTtest4doc_1 | D:\work\test4.doc |

TABLE 2

| email | email attachment | | |
|---|---|---|---|
| identifier | identifier | path of local file | time tag |
| NOTE123Q | test1doc_1 | D:\work\test1.doc | 2007-08-05-12:00:00 |
| NOTE584ATW | test2doc_1 | D:\work\test1.doc | 2007-08-06-12:05:00 |

In step S103 of determining that the email attachment is modified, a user modifies and stores the attached email attachment, and it is determined that the email attachment is modified by receiving an operation of storing the email attachment by the user.

In step S104 of replacing the local file with the modified email attachment according to the corresponding relationship record automatically, the user is notified to determine whether the local file is replaced with the modified email attachment; and the local file is replaced with the modified email attachment according to the corresponding relationship record automatically if the determination is “yes”, more specifically, the local file corresponding to the path of the local file in the corresponding relationship record is replaced with the modified email attachment.

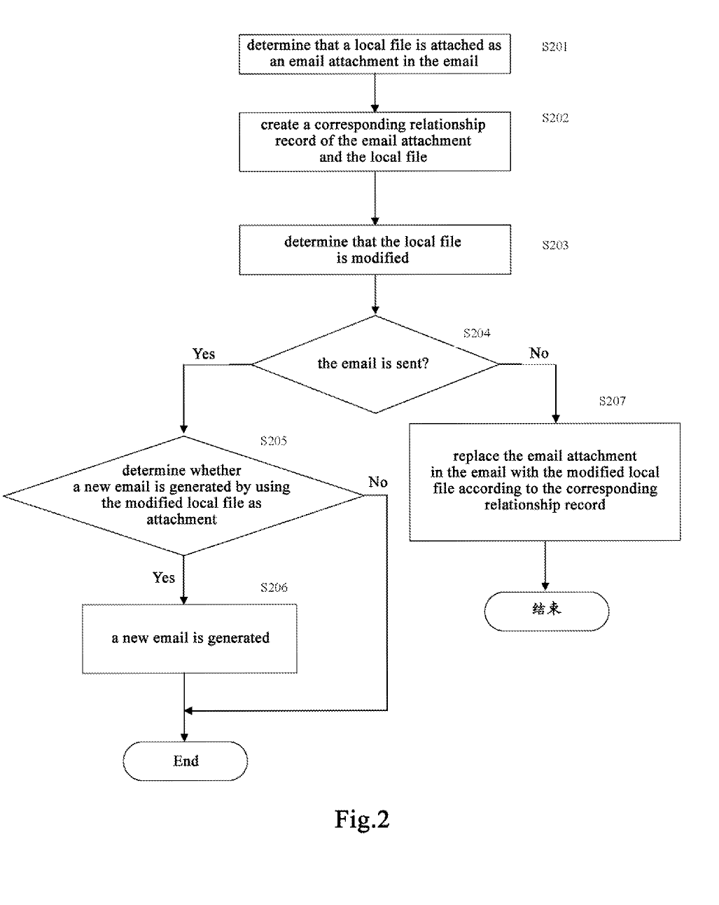

FIG. 2 shows a method for processing email attachments according to the second and third embodiment of the present invention, comprising: in step S201, determining that a local file is attached as an email attachment in the email; in step S202, creating a corresponding relationship record of the email attachment and the local file; in step S203, determining that the local file is modified; in step S204, judging whether the email is sent; in step S207, determining that the email is not sent yet, replacing the email attachment in the email with the modified local file.

According to an embodiment of the present invention, if it is determined that the email is not sent yet, the user is notified to determine whether the email attachment in the email is replaced with the modified local file; and the email attachment in the email is replaced with the modified local file according to the corresponding relationship record automatically if the determination is “yes”. More specifically, by receiving a notification of storing the local file, the user is notified to determine whether the email attachment in the email is replaced with the modified local file.

According to another embodiment of the present invention, at a predetermined time, in response to receiving an operation of sending email, the modification of the local file is determined by comparing the modified time of the local file recorded in the table of corresponding relationship with the current modified time of the local file, more specifically, if the current modified time of the local file is delayed with respect to modified time of the local file recorded in the table of corresponding relationship, then it can be determined that the local file is modified, and the user can also set a predetermined interval to detect the modification of the local file.

According to another embodiment of the present invention, in response to receiving an operation of sending email, the modification of the local file is determined by comparing the file size of the local file recorded in the table of corresponding relationship with the current file size of the local file. The email attachment in the email is replaced with the modified local file according to the corresponding relationship record automatically in response to the result of the determination is yes, more specifically, the email attachment corresponding to the email identifier in the corresponding relationship record is replaced with the modified local file. In determining the modification of the local file by utilizing the modified time tag of the local file or the file size, the modified time tag of the local file and the file size in the corresponding relationship record also need to be modified, and the modified time tag for storing the local file in the corresponding relationship record is replaced with current modified time tag of the local file or the file size.

In step S205 of determining the email is sent, the user determines whether a new email including the email attachment is generated, wherein the email attachment of the new email is the modified local file; in step S206, if the result of the determination is “yes”, a new email is generated automatically; if the result of the determination is “no”, the flow ends.

According to an embodiment of the present invention, based on the email identifier obtained from the corresponding relationship record, the information of recipient and carbon copy object and the information of email title is obtained from the email head corresponding to the email, thereby enabling the newly generated email to include the information of recipient and carbon copy object and the information of email title in the original email and facilitating the operation of re-sending email by user.

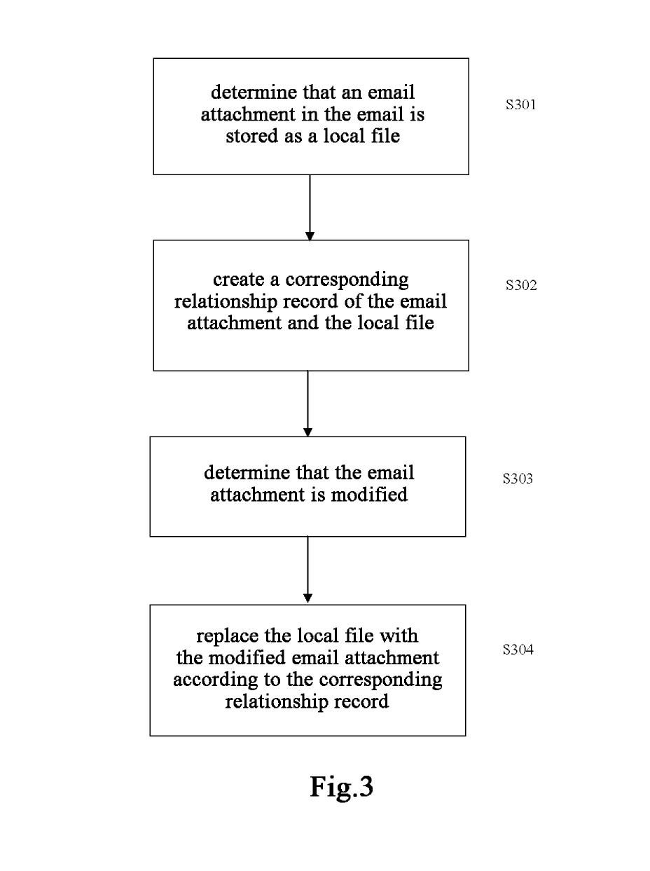

FIG. 3 shows a method for processing the email attachment according to the fourth embodiment of the present invention, comprising: in step S301, determining that an email attachment in the email is stored as a local file; in step S302, creating a corresponding relationship record of the email attachment and the local file; in step S303, determining that the email attachment is modified; and in step S304, replacing the local file with the modified email attachment according to the corresponding relationship record automatically. Table 1 or 2 shows the created corresponding relationship record of the email attachment and the local file. In step S304 of replacing the local file with the modified email attachment according to the corresponding relationship record automatically, according to an embodiment of the present invention, the user is notified of whether the local file is replaced with the modified email attachment, wherein the modification of the email attachment is determined by receiving an operation of storing the email attachment; and the local file is replaced with the modified email attachment according to the corresponding relationship record automatically in response to the result of the determination is “yes”.

According to an embodiment of the present invention, the user modifies and stores the attached email attachment before forwarding or replying email; determines that the email attachment is modified by receiving an operation of storing the email attachment by the user; notifies the user to determine whether the local file is replaced with the modified email attachment; the local file is replaced with the modified email attachment according to the corresponding relationship record automatically in response to the result of determination is “yes”; more specifically, the local file corresponding to the path of the local file in the corresponding relationship record is replaced with the modified email attachment.

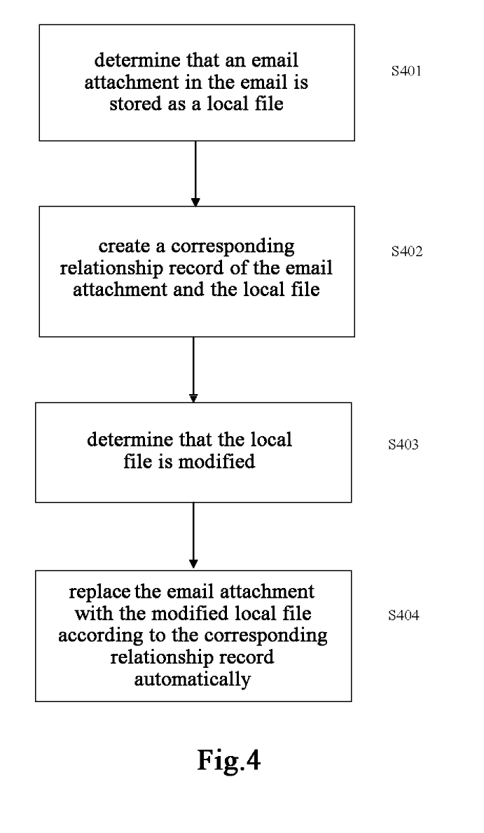

FIG. 4 shows a method for processing the email attachment according to the fifth embodiment of the present invention, comprising: in step S401, determining that an email attachment in the email is stored as a local file; in step S402, creating a corresponding relationship record of the email attachment and the local file; in step S403, determining that the email attachment is modified; and in step S404, replacing the email attachment in the email with the modified local file according to the corresponding relationship record.

According to an embodiment of the present invention, the user is notified to determine whether the email attachment is replaced with the modified local file; and the email attachment is replaced with the modified local file according to the corresponding relationship record automatically in response to the result of the determination is “yes”.

According to an embodiment of the present invention, upon receiving a notification of storing the local file, the user is notified to determine whether the email attachment is replaced with the modified local file, thereby preparing for the further forwarding and replying.

According to another embodiment of the present invention, at predetermined time, in response to an initiation of the email system, the modification of the local file is determined by comparing the modified time of the local file recorded in the table of corresponding relationship with the current modified time of the local file, more specifically, if the current modified time of the local file is delayed with respect to modified time of the local file recorded in the table of corresponding relationship, then it can be determined that the local file is modified, and the user can also set a predetermined interval to detect the modification of the local file.

According to another embodiment of the present invention, upon receiving an operation of sending email, the modification of the local file is determined by comparing the file size of the local file recorded in the table of corresponding relationship with the current file size of the local file. The email attachment is replaced with the modified local file according to the corresponding relationship record automatically in response to the result of the determination is “yes”, more specifically, the email attachment corresponding to the email identifier in the corresponding relationship record is replaced with the modified local file. In determining the modification of the local file by utilizing the modified time tag of the local file or the file size, the modified time tag of the local file and the file size in the corresponding relationship record also need to be modified, and the modified time tag for storing the local file or the file size in the corresponding relationship record is replaced with current modified time tag of the local file or the file size.

The method for processing email attachments according to the embodiments of the present invention could be implemented in the email system of the client, according to an embodiment, a corresponding relationship record in embodiments of the present could be uploaded to the mail server from the client in advance, and the user could download the corresponding relationship record to a geographically different computer from the mail server while working in a geographically different location, as well as the local file that is required to synchronize is copied onto another computer, thereby matching the path of the local file that is required to synchronize with the path of the local file in the corresponding relationship record, and holding the synchronization of the email attachment and the local file on another computer working in a geographically different location.

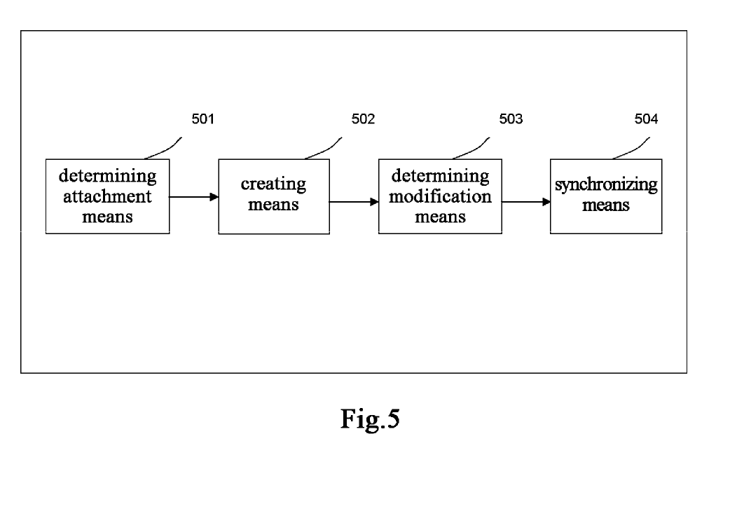

Based on the same inventive concept, the present invention also provides a system for processing email attachments, and FIG. 5 shows a block diagram of the system for processing email attachments according to the first embodiment of the present invention. As shown, the system for processing email attachments comprises: determining attachment means 501 configured to determine that a local file is attached as an email attachment in the email; creating means 502 configured to create a corresponding relationship record of the email attachment and the local file; determining modification means 503 configured to determine that the email attachment is modified; and synchronizing means 504 configured to replace the local file with the modified email attachment according to the corresponding relationship record automatically.

According to an embodiment of the present invention, the synchronizing means 504 is further configured to notify the user to determine whether the local file is replaced with the modified email attachment, and replace the local file with the modified email attachment according to the corresponding relationship record automatically in response to the result of the determination is “yes”. The corresponding relationship record includes identification information of the email attachment and the identification information of the local file, the identification information of the email attachment includes the email attachment identifier for identifying the email attachment uniquely, the identification information of the local file includes a path of the local file, according to an embodiment of the present invention, the identification information of the email attachment may also include email identifier, modified time tag of the local file or local file size.

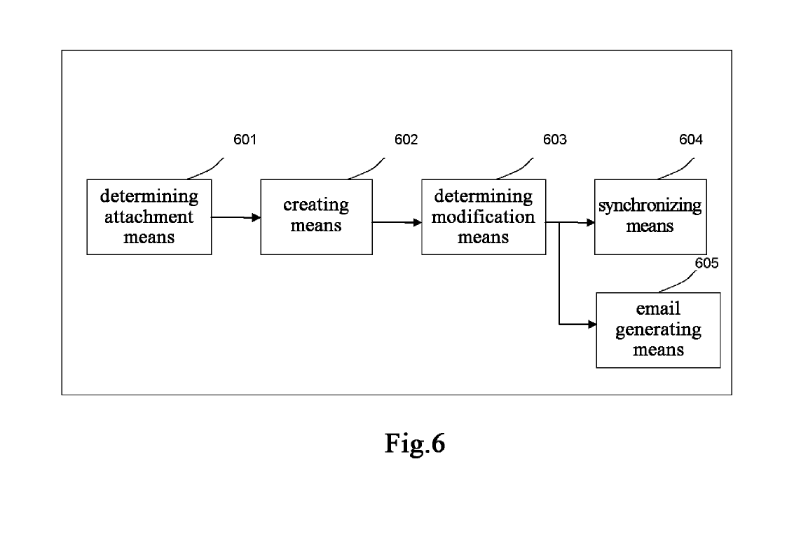

FIG. 6 shows a block diagram of the system for processing email attachments according to the second and third embodiments of the present invention. According to the second embodiment of the present invention, the system for processing email attachments comprises: determining attachment means 601 configured to determine that a local file is attached as an email attachment in the email; creating means 602 configured to create a corresponding relationship record of the email attachment and the local file; determining modification means 603 configured to determine that the local file is modified and that the email is not sent yet; and synchronizing means 604 configured to replace the email attachment in the email with the modified local file according to the corresponding relationship record, and update the corresponding relationship record. According to an embodiment of the present invention, the synchronizing means is further configured to notify user to determine whether the email attachment in the email is replaced with the modified local file; and replace the email attachment in the email with the modified local file according to the corresponding relationship record automatically and update the corresponding relationship record in response to the result of the determination is “yes”.

According to the third embodiment of the present invention, it further comprises email generating means 605, wherein the determining modification means is further configured to determine that the local file is modified and that the email is sent already, notify user to determine whether a new email including the email attachment is generated, wherein the email attachment of the new email is the modified local file; and the email generating means 605 is configured to generate the new email automatically according to the modified corresponding relationship record in response to the result of the determination is “yes”.

The corresponding relationship record includes identification information of the email attachment and the identification information of the local file, the identification information of the email attachment includes the email attachment identifier for identifying the email attachment uniquely, the identification information of the local file includes a path of the local file, according to an embodiment of the present invention, the identification information of the email attachment may also include the email identifier, the modified time tag of the local file or the local file size.

According to an embodiment of the present invention, the identification information of the local file further includes a modified time tag of the local file, and it is determined that the email attachment is modified by comparing the modified time tag of the local file in the corresponding relationship record with the current modified time tag of the local file. The synchronizing means is further configured to replace the modified time tag of the local file in the corresponding relationship record with the modified time tag of the modified local file in response to determining that the email attachment is modified by comparing the modified time tag of the local file in the corresponding relationship record with current modified time tag of the local file.

The system for processing email attachments according to the above embodiments of the present invention could be implemented in the email system of the client as a plug-in.

The method and system for processing email attachments according to the embodiments of the present invention enables an association of the local file and the email attachment that do not relate to each other, and enables to notify the user of a choice for replacing the file if one of them is modified, and updates another file, thereby saving workload and time cost for re-editing, re-storing and re-uploading attachment by the user.

As appreciated, at least some aspects of the present invention may be alternatively embodied as program product. The program defining the functions related to the present invention may be transferred to a data storage system or a computer system through a variety of signal carrier media, which includes but is not limited to, non-writable memory medium (e.g. CD-ROM), writable memory medium (e.g. floppy disk, hard driver, read/write CD ROM, optical medium) and communication medium including for example Ethernet computer and telephone network or the like. Thus, it should be understood that, in such signal carrier media, when it carries or encodes computer readable instruction for managing the method functions in the present invention, it represents the alternative embodiment of the present invention.

The present invention may be implemented in hardware, software, firmware or a combination thereof. The present invention may be implemented in a single computer system in a centralized manner or in a distributed manner, in such a distributed manner, different parts are distributed into several interconnected computer systems. Any computer system or other apparatus suitable to perform the method described herein are applicable. Preferably, the present invention is implemented in a combination of computer software with computer hardware, in this manner, when the computer programs are loaded and executed, the computer system is controlled to perform the method of the present invention or construct the system of the present invention.

The description of the preferable embodiments of the present invention is given for illustration. The above description of the preferable embodiments is not exhaustive, and is not intended to limit the present invention to the disclosed explicit form; it is obvious that many modifications and alternations are possible based on the above study. For those skilled in the art, it is obvious that such modifications and changes fall into the scope of the present invention defined by the appended claims.

1. A method for processing email attachment, comprising:
determining in an e-mail system executing in memory by at least one processor of a computer, that a local file is attached as an email attachment in an email;
creating a corresponding relationship record of the email attachment and the local file;
determining that the email attachment is modified; and
replacing the local file with the modified email attachment according to the corresponding relationship record automatically.

2. The method according to claim 1, wherein replacing the local file with the modified email attachment according to the corresponding relationship record automatically further comprising:
notifying the user to determine whether the local file is replaced with the modified email attachment, and
replacing the local file with the modified email attachment according to the corresponding relationship record automatically in response to the result of the determination is “yes”.

3. The method according to claim 1, wherein the corresponding relationship record includes identification information of the email attachment and identification information of the local file.

4. The method according to claim 3, wherein the identification information of the email attachment includes email attachment identifier for identifying the email attachment uniquely, the identification information of the local file includes a path of the local file.

5. The method according to claim 1, wherein it is determined that the email attachment is modified by receiving an operation of storing the email attachment.

6. A method for processing email attachment, comprising:
determining in an e-mail system executing in memory by at least one processor of a computer, that a local file is attached as an email attachment in the email;
creating a corresponding relationship record of the email attachment and the local file;
determining that the local file is modified and that the email is not sent yet; and
replacing the email attachment in the email with the modified local file according to the corresponding relationship record.

7. The method according to claim 6, wherein replacing the email attachment in the email with the modified local file according to the corresponding relationship record further comprising:
notifying the user to determine whether the email attachment in the email is replaced with the modified local file; and
replacing the email attachment in the email with the modified local file according to the corresponding relationship record automatically and updating the corresponding relationship record in response to the result of the determination is “yes”.

8. The method according to claim 6, further comprising:
determining that the local file is modified and that the email is sent already, notifying the user to determine whether a new email including email attachment is generated, wherein email attachment of the new email is the modified local file; and
the new email is generated automatically according to the updated corresponding relationship record in response to the result of the determination is “yes”.

9. The method according to claim 6, wherein the corresponding relationship record includes identification information of the email attachment and identification information of the local file.

10. The method according to claim 9, wherein the identification information of the email attachment includes the email attachment identifier for identifying the email attachment uniquely, the identification information of the local file includes a path of the local file.

11. The method according to claim 10, wherein it is determined that the email attachment is modified by receiving a notification of storing the local file.

12. The method according to claim 11, wherein the identification information of the local file further includes a modified time tag of the local file, and it is determined that the email attachment is modified by comparing the modified time tag of the local file in the corresponding relationship record with the current modified time tag of the local file.

13. The method according to claim 12, wherein replacing the modified time tag of the local file in the corresponding relationship record with the modified time tag of the modified local file in response to determining that the email attachment is modified by comparing the modified time tag of the local file in the corresponding relationship record with current modified time tag of the local file.

14. A system for processing email attachment, comprising:
a computer with memory and at least one processor;
an e-mail system executing in the memory by the at least one processor of the computer;
determining attachment means coupled to the e-mail system and configured to determine that a local file is attached as an email attachment in the email;
creating means coupled to the e-mail system and configured to create a corresponding relationship record of the email attachment and the local file;
determining modification means coupled to the e-mail system and configured to determine that the email attachment is modified; and
synchronizing means coupled to the e-mail system and configured to replace the local file with the modified email attachment according to the corresponding relationship record automatically.

15. The system according to claim 14, the synchronizing means is further configured to notify user to determine whether the local file is replaced with the modified email attachment, and replace the local file with the modified email attachment according to the corresponding relationship record automatically in response to the result of the determination is “yes”.

16. The system according to claim 14, wherein the corresponding relationship record includes the identification information of the email attachment and the identification information of the local file.

17. The system according to claim 16, wherein the identification information of the email attachment includes the email attachment identifier for identifying the email attachment uniquely, the identification information of the local file includes a path of the local file.

18. The method according to claim 14, wherein it is determined that the email attachment is modified by receiving an operation of storing the email attachment.

19. A system for processing email attachment, comprising:
a computer with memory and at least one processor;
an e-mail system executing in the memory by the at least one processor of the computer;
determining attachment means coupled to the e-mail system and configured to determine that a local file is attached as an email attachment in the email;
creating means coupled to the e-mail system and configured to create a corresponding relationship record of the email attachment and the local file;
determining modification means coupled to the e-mail system and configured to determine that the local file is modified and that the email is not sent yet; and
synchronizing means coupled to the e-mail system and configured to replace the email attachment in the email with the modified local file according to the corresponding relationship record, and update the corresponding relationship record.

20. The method according to claim 19, the synchronizing means is further configured to:
notify the user to determine whether the email attachment in the email is replaced with the modified local file; and
replace the email attachment in the email with the modified local file according to the corresponding relationship record automatically and update the corresponding relationship record in response to the result of the determination is “yes”.

21. The system according to claim 19, further comprising the email generating means, wherein the determining modification means is configured to:
determine that the local file is modified and that the email is sent already, notify user to determine whether a new email including email attachment is generated, wherein email attachment of the new email is the modified local file; and
the email generating means is configured to, generate the new email automatically according to the updated corresponding relationship record in response to the result of the determination is “yes”.

22. The system according to claim 19, wherein the corresponding relationship record includes the identification information of the email attachment and the identification information of the local file.

23. The system according to claim 24, wherein the identification information of the email attachment includes the email attachment identifier for identifying the email attachment uniquely, the identification information of the local file includes a path of the local file.

24. The system according to claim 23, wherein the identification information of the local file further includes a modified time tag of the local file, and it is determined that the email attachment is modified by comparing the modified time tag of the local file in the corresponding relationship record with current modified time tag of the local file.

25. The system according to claim 24, the synchronizing means is further configured to replace the modified time tag of the local file in the corresponding relationship record with the modified time tag of the modified local file in response to determining that the email attachment is modified by comparing the modified time tag of the local file in the corresponding relationship record with current modified time tag of the local file.
